(19) United States
(12) Patent Application Publication
(10) Pub. No.: US 2026/0234746 A1
(43) Pub. Date: Aug. 13, 2026

(54) Method for Extraction of Lithium

(71) Applicant: Rio Tinto Leaching Technologies Pty Limited, Melbourne VIC (AU)

(72) Inventors: Samuel Keith Chatwin, Melbourne VIC (AU); Mikaela Jenkins, Melbourne VIC (AU); David Bruce Dreisinger, Melbourne VIC (AU)

(21) Appl. No.: 19/537,287

(22) Filed: Feb. 11, 2026

(30) Foreign Application Priority Data
Feb. 12, 2025 (AU) 2025900380

(51) Int. Cl. C22B 3/08; C22B 3/06

(52) U.S. Cl. CPC C22B 3/08; C22B 3/06

(57) ABSTRACT

A method for the extraction of lithium from a feed mixture comprising ore containing lithium, the method comprising the steps of: preparing an initial aqueous suspension of the mixture without undertaking roasting of the feed mixture of ores by maintaining the initial temperature of the suspension below 100° C.; adding sulphuric acid and an alkali sulphate to the suspension; pressurizing the aqueous suspension in a reaction vessel to obtain a pressurized suspension such that pressure within the reaction vessel does not exceed 4000 kPa; while maintaining temperature of the pressurized suspension to prevent boiling of the aqueous suspension to obtain a leachate comprising dissolved lithium sulphate.

### TECHNICAL FIELD

The present invention relates to a method and system for extracting lithium. This method is particularly suitable for lithium extraction from ore mixtures having clays containing lithium.

### BACKGROUND

Any references to methods, apparatus or documents of the prior art are not to be taken as constituting any evidence or admission that they formed, or form part of the common general knowledge.

Lithium containing clays are receiving attention due to the rapidly growing demand for lithium. There are three main known methods for extracting lithium from lithium containing clays.

The first type of known method involves mixing and roasting the lithium containing clay material with sulphates such as calcium sulphate, sodium sulphate and the like. The leaching effect of lithium is considerable, but elements such as fluorine, calcium potassium and the like are introduced into the solution which can necessitate the need for later purification.

The second method (alkaline method) adopts lime and sodium hydroxide for roasting and as a result large quantities of slag and results in high equipment maintenance cost.

The third method (acid method) directly uses sulfuric acid for low-temperature curing, the leaching rate is over 90 percent. However, the quantity or dosage of sulphuric acid required is large which not only increases costs but also leads to higher rates of corrosion of equipment.

Overall, there is a need for improved lithium extraction methods or systems from lithium containing clays that result in lower costs, reduce carbon emissions during the extraction process and provide improved lithium extraction yields.

### SUMMARY OF INVENTION

In a first aspect, the invention provides a method for the extraction of lithium from a feed mixture comprising ore containing lithium, the method comprising the steps of:
preparing an initial aqueous suspension of the mixture without undertaking roasting of the feed mixture of ores;
adding sulphuric acid or a sulphuric acid precursor and an alkali sulphate to the suspension;
pressurizing the aqueous suspension in a reaction vessel to obtain a pressurized suspension to obtain a leachate comprising dissolved lithium sulphate.

In an embodiment, the ore containing lithium is selected from a clay containing lithium, a lithium bearing pegmatite and jadarite.

In an embodiment, the clay containing lithium is selected from smectite clay and illite clay.

In an embodiment, the lithium bearing pegmatite is selected from spodumene, lepidolite, petalite, amblygonite and zinnwaldite.

In an embodiment, the lithium bearing pegmatite is selected from lepidolite and petalite.

In an embodiment, the feed mixture comprising ore containing lithium may be derived from tailings or tailing mixtures. The tailings or tailings mixtures may be any lithium-rich or lithium-containing tailings. For example, the tailings or tailings mixtures may result from processing lithium containing ores such as spodumene, lepidolite, petalite, amblygonite, zinnwaldite and jadarite.

In an embodiment, the feed mixture comprising ore containing lithium having a fine particle size. In an embodiment, the feed mixture comprises ore containing lithium having a particle size such that 80% of the feed material passes through a screen or mesh size (P80) of less than 45 μm, less than 30 μm, less than 20 μm, less than 15 μm or less than 10 μm. In another embodiment, the feed mixture comprises particles having a P80 size ranging from 10 μm to 20 μm and more preferably 12 μm to 15 μm.

In an embodiment, the step of preparing an aqueous suspension of the mixture is carried out to permit the reaction of the acid with the carbonate in the feed, and for the evolved gas to reduce the amount of carbonates in the feed material prior to the step of pressurising the reaction.

In an embodiment, the step of preparing the initial aqueous suspension is carried out at a temperature to maintain the suspension in liquid phase under atmospheric conditions. In another embodiment, the step of preparing the initial aqueous suspension is carried out to maintain the temperature of the suspension below 100° C.. In yet another embodiment, the step of preparing the initial aqueous suspension is carried out to maintain the temperature of the suspension between room temperature and about 100° C.. In a further embodiment, the step of preparing the initial aqueous suspension is carried out to maintain the temperature of the suspension between about 50° C. and about 100 degrees Celsius. In a still further embodiment, the step of preparing the initial aqueous suspension is carried out to maintain the temperature of the suspension between about 70° C. and about 90° C..

In an embodiment, the step of pressurising the reaction is carried out to maintain pressure within the reaction vessel below 4000 kPa. In another embodiment, the step of pressurising the reaction is carried out to maintain pressure within the reaction vessel between about 500 kPA and about 4500 kPA, preferably in the range of 500 kPa to 4000 kPa and more preferably in the range of 1000 kPA and about 3500 kPA. In another embodiment, the step of pressurising the reaction is carried out to maintain pressure within the reaction vessel below 3000 kPa. In yet another embodiment, the step of pressurising the reaction is carried out to maintain pressure within the reaction vessel between about 1000 kPA and about 3500 kPA. In a further embodiment, the step of pressurising the reaction is carried out to maintain pressure within the reaction vessel between about 1000 kPA and 2000 kPA.

In an embodiment, the pressurised suspension is maintained at a temperature below 300° C.. In another embodiment, the pressurised suspension is maintained at a temperature below the boiling point of the aqueous suspension. In yet another embodiment, the pressurised suspension is maintained at a temperature between about 150° C. and about 250° C.. In a further embodiment, the pressurised suspension is maintained at a temperature between about 170° C. and about 230° C.. In a still further embodiment, the pressurised suspension is maintained at a temperature between about 190° C. and about 220° C..

In another aspect, the invention provides a method for the extraction of lithium from a feed mixture comprising ore containing lithium, the method comprising the steps of:
preparing an initial aqueous suspension of the mixture without undertaking roasting of the feed mixture and maintaining the initial temperature of the suspension below 100 degrees Celsius;
adding sulphuric acid or a sulphuric acid precursor and an alkali sulphate to the suspension; and
pressurizing the aqueous suspension in a reaction vessel to obtain a pressurized suspension such that pressure within the reaction vessel does not exceed 4000 kPa;
while maintaining temperature of the pressurized suspension to prevent boiling of the aqueous suspension and obtain a leachate comprising dissolved lithium sulphate.

In an embodiment, the alkali sulfate comprises a sulfate of a monovalent cation. In another embodiment, the alkali sulfate comprises a sulfate of sodium or potassium. In an embodiment, the alkali sulphate comprises sodium sulphate.

In an embodiment, the step of adding sulphuric acid comprises adding concentrated sulphuric acid.

In an embodiment, the pressure within the reaction vessel is in the range of 500 kPa to 4500 kPa, preferably in the range of 500 kPa to 4000 kPa and more preferably in the range of 1000 kPa to 3500 kPa. In another embodiment, the pressure within the reaction vessel is below 4000 kPA, and preferably below 3000 kPa. In yet another embodiment, the pressure within the reaction vessel is in the range of about 1000 kPA to about 3500 kPA. In a further embodiment, the pressure within the reaction vessel is in the range of about 1000 kPA to 2000 kPA.

In an embodiment, the method further comprises the step of extracting lithium sulphate from the leachate.

In an embodiment, the feed mixture comprising ore containing lithium is derived from tailings. The tailings may be any lithium-rich or lithium-containing tailings. For example, the tailings may result from processing lithium containing ores such as spodumene, lepidolite, petalite, amblygonite, zinnwaldite and jadarite.

In an embodiment, the step of preparing an aqueous suspension of the feed mixture is carried out to permit the reaction of the acid with carbonate in the feed, and for the evolved gas to reduce the amount of carbonates in the feed material prior to the step of pressurising the aqueous suspension.

In an embodiment, the step of preparing an aqueous suspension of the feed mixture is carried out to achieve a predetermined solids concentration in the suspension.

In an embodiment, the predetermined solid concentration is less than 50% (w/w) and more preferably in the range of 25% to 40% (w/w).

In an embodiment, temperature of the initial suspension is below 100 degrees Celsius, preferably below 90 degrees, and more preferably below 85 degrees. In another embodiment, the temperature of the initial suspension is between room temperature and about 100° C.. In yet another embodiment, the temperature of the initial suspension is between about 50° C. and about 100° C.. In a further embodiment, the temperature of the initial suspension is between about 70° C. and about 90° C..

In an embodiment, temperature of the pressurized suspension is maintained below 300° C., and preferably below 250° C.. In another embodiment, the temperature of the pressurized suspension is maintained at a temperature below the boiling point of the aqueous suspension. In yet another embodiment, the temperature of the pressurized suspension is between about 150 degrees Celsius and about 250° C.. In a further embodiment, the temperature of the pressurized suspension is between about 170° C. and about 230° C.. In a still further embodiment, the temperature of the pressurized suspension is between about 190° C. and about 220 degrees Celsius.

In an embodiment, the initial aqueous suspension is maintained at an initial temperature below 100° C. for a time period sufficient to remove carbonates from the feed material prior to commencing the step of pressurizing the aqueous suspension. In another embodiment, the initial aqueous suspension may be maintained at an initial temperature below 100° C. for a time period in the range from about a minute up to about five days, preferably less than 24 hours and more preferably less than 5 hours. In yet another embodiment, the initial aqueous suspension is maintained at an initial temperature below 100° C. for a time period in the range of 30 minutes to 180 minutes.

In an embodiment, the step of pressurizing is carried out for a time period sufficient to extract the lithium from the feed material. In another embodiment, the step of pressurizing is carried out for a time period in the range from about a minute up to about five days, preferably less than 24 hours and more preferably less than 5 hours. In yet another embodiment, the step of pressurizing is carried out for a time period in the range of 30 minutes to 180 minutes. In a further embodiment, the step of pressurizing is carried out for a time period in the range of 30 minutes to 90 minutes. In a still further embodiment, the step of pressurizing is carried out for a time period of at least 60 minutes.

In an embodiment, the method further comprises the step of adding a antifoaming agent, preferably calcium lignosulphate.

In a preferred embodiment, less than 500 kg of concentrated sulphuric acid per tonne of ore mixture is added to the aqueous suspension.

In a preferred embodiment, less than 450 kg of concentrated sulphuric acid per tonne of feed mixture is added to the aqueous suspension.

In an embodiment, alkali sulfate is added in a stoichiometric amount to permit substitution of lithium in the feed material with the alkali cation. In another embodiment, less than 1,000 kg of alkali sulphate per tonne of feed mixture is added to the aqueous suspension. In another embodiment, at least 10 kg of alkali sulphate per tonne of feed mixture is added to the aqueous suspension. In yet another embodiment, at least 20 kg of alkali sulphate per tonne of feed mixture is added to the aqueous suspension. In a preferred embodiment, at least 40 kg of alkali sulphate per tonne of feed mixture is added to the aqueous suspension. In a preferred embodiment, at least 50 kg of alkali sulphate per tonne of feed mixture is added to the aqueous suspension. In another embodiment, least 75 kg and more preferably at least 100 kg of alkali sulphate per tonne of feed mixture is added to the aqueous suspension. In yet another embodiment, the amount of alkali sulphate per tonne of feed mixture added to the aqueous suspension may be between about 10 kg and about 1,000 kg, between about 50 kg and about 1,000 kg, between about 10 kg and about 500 kg, between about 20 kg and about 500 kg, between about 50 kg and about 500 kg, between about 15 kg and about 250 kg, between about 20 kg and about 250 kg, between about 50 kg and about 250 kg, between about 20 kg and about 200 kg, between about 50 kg and about 200 kg, between about 20 kg and about 150 kg, or between about 50 kg and about 150 kg.

In an embodiment, initial first quantity of sulphuric acid is added to the suspension wherein the temperature of the suspension is below 100° C. and wherein a subsequent second quantity of sulphuric acid is added to the suspension when the suspension is pressurized in the reaction vessel.

In an embodiment, the first quantity of sulphuric acid is from at least 45% up to at least 70% of the total sulphuric acid being added to the suspension and wherein the second quantity of sulphuric acid is from at least 30% up to at least 55% of the total sulphuric acid being added.

In another embodiment, the first quantity of sulphuric acid is at least 50% and more preferably at least 60% of the total sulphuric acid being added to the suspension and wherein the second quantity of sulphuric acid is 50% or less than 50% of the total sulphuric acid being added and more preferably 40% or less than 40% of the total sulphuric acid being added.

In an embodiment, the pH of the suspension after the initial first quantity of sulphuric acid is added is from at least 0.5 up to at least 3.

In an embodiment, the solid concentration of the suspension after the initial first quantity of sulphuric acid is added is less than 50% (w/w) and more preferably in the range of 25% to 40% (w/w).

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a process flow diagram for a method 100 of extracting lithium from a feed mixture comprising ore containing lithium.

FIG. 2 is a detailed testing flowsheet of the Examples 1, 2 and 3 that were treated in accordance with method 100.

FIGS. 3 and 4 show variation of Lithium and Boron extraction as a function of temperature.

### DETAILED DESCRIPTION OF PREFERRED EMBODIMENTS

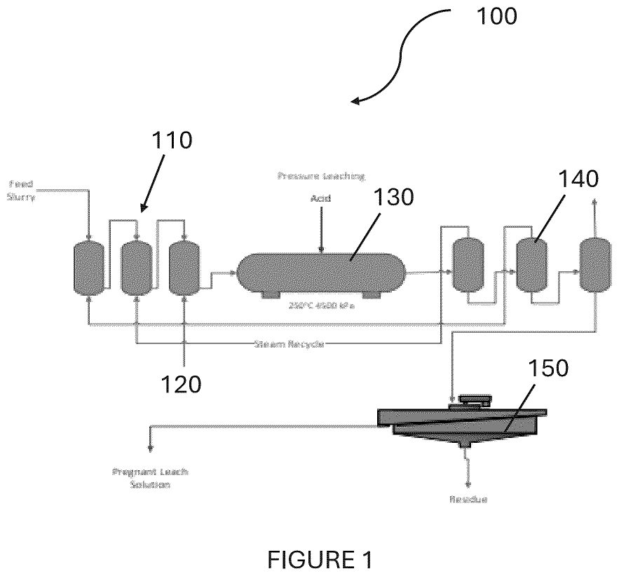

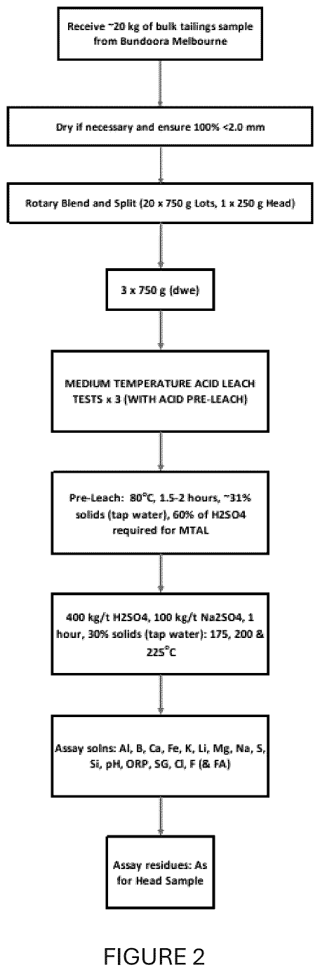

FIGS. 1 and 2 illustrate a process flow diagram in accordance with an embodiment of the method of the present disclosure.

FIG. 1 provides a schematic process flow diagram for a method embodiment 100 for efficiently leaching lithium from a feed mixture comprising ore containing lithium. A feed slurry comprising a feed mixture undergoes a pre-leaching step in pre-leaching containers 110 where the temperature is maintained below 100° C. and no roasting is carried out on the feed mixture before introducing the feed mixture into the pre-leaching container 110. The pre-leaching step requires the addition of a first quantity of concentrated sulphuric acid, a quantity of alkali sulphate and an antifoaming agent as will be discussed in further detail in the following sections. Reference numeral 120 denotes addition of the first quantity of concentrated sulphuric acid and the antifoaming agent. Any conventional methods may be used for mixing the slurry.

After the pre-leaching step has been completed over a period of 1-2 hours, the acidified slurry was added to autoclave vessels 130. The acidified slurry is subjected to pressures of up to 4500 kPa at temperatures under 300° C. while a second quantity of concentrated sulphuric acid is added into the autoclave vessels 130. An antifoaming agent may also be added into the autoclave vessels 130 while undertaking the leaching in the autoclave vessels 130. The leaching step in the pressurised autoclave vessels 130 may be carried out for a specified period of time. After the leaching step is completed the pregnant leach solution with dissolved Lithium ions may be diverted into collection chambers 140. A separation chamber 150 may be used to separate the pregnant leach solution from the other solids in the pressure treated slurry. The solids may also be recovered and in some instances fed back to the initial feed slurry being introduced into the pre-leaching containers 110.

Without being bound by theory, it is hypothesized that adding all of the acid upfront in the pre-leaching step would increase the risk of dissolving unwanted impurities/gangue into the leach solution. However, in embodiments involving the pre-leaching step being carried out in the pre-leaching containers 110, by adding an initial quantity of sulphuric acid the pre-leaching step, it is possible to first permit the reaction of the acid with the carbonate in the feed, and for the evolved gas to remove carbonates from the feed material prior to commencing the leaching step. Optionally, it was found that an antifoaming agent could be added to minimise foam formation, which also resulted in an improvement in the subsequent leaching step.

It is also hypothesized, without being bound by theory, that the addition of an alkali sulphate having a monovalent cation such as sodium sulphate or potassium sulphate may present surprising and unexpected benefits. In the presently described examples, the addition of sodium sulphate is relevant for reducing the amount of sulphuric acid needed for the extraction of lithium. However, it is also hypothesized that at least some of the sodium sulphate in solution may be involved in the mechanism of lithium extraction from the feed material. The lithium is structurally incorporated into the mineral, rather than just being adsorbed onto surfaces, sitting in pores, or between interlayer spaces. Therefore, the extraction is required to release lithium that is bound inside the octahedral sheet (coordinated by oxygen/hydroxyls). The sodium cations of the sodium sulfate are able to participate in an ion exchange process, whereby the sodium ions replace the lithium in the mineral lattice thereby further facilitating the Lithium leaching process. In this regard, it was also noted that relatively larger quantities of sodium sulphate, such as at least 40 kg of sodium sulphate per tonne of feed mixture may be needed to avail benefits of the ion exchange process.

The following passages illustrate non-limiting examples for samples that were processed in accordance with the process 100. The method described herein (as shown in FIG. 2) will be referred to as a medium temperature acid leaching method for reasons that will be discussed in the foregoing sections. A sample of clay tailings (gangues) was used as a feed mixture. These tailings are typically aqueous suspensions (with lithium containing clays among other solids). Initial sample analysis provided the following head assay for the sample as summarised in the tables 1 and 2 below.

Clay tailings leach feed sample - Head Analysis

| | Al | B | Ca | Fe | K | Li | Mg | Na |
|---|---|---|---|---|---|---|---|---|
| Sample | (%) | (%) | (%) | (%) | (%) | (%) | (%) | (%) |
| Clay | 4.85 | 2.16 | 2.73 | 2.35 | 2.74 | 0.22 | 4.69 | 5.1 |
| tailings | | | | | | | | |

Clay tailings leach feed sample - Head Analysis

| | S_{TOTAL} | | Si | Cl⁻ | F⁻ | C_{TOTAL} | C_{ORGANIC} | CO₃ |
|---|---|---|---|---|---|---|---|---|
| Sample | (%) | S_{SULPHIDE}(%) | (%) | (%) | (%) | (%) | (%) | (%) |
| Clay | 0.28 | <0.02 | 19.6 | 0.30 | 0.51 | 1.44 | 0.48 | 4.8 |
| tailings | | | | | | | | |

The above elemental analysis confirmed the presence of Lithium (among other elements) in the process tailings. Elemental analysis for the slurry was carried out using X-Ray Fluorescence (XRF).

The clay tailings samples provided for the test-work were representative portions (1000 g lots) that were partially dried (to approximately 9% moisture). The clay tailings samples discussed herein mainly contain smectites (hectorite, etc.) and illite. However, it would be understood that the method described may utilise tailing samples that include other lithium ores such as spodumene, amblygonite, zinnwaldite, lepidolite, petalite and jadarite. Particle size distribution of the clay tailings samples indicated P80 at 14 μm. P80 refers to the particle size at which 80% of the tailing sample (in its dry state) passes through a screen or mesh size of 14 μm.

Due to relatively high carbonate content in the tailings samples foaming was found to occur on the addition of acid. In order to control some of the foaming, in an initial step a first quantity of concentrated sulphuric acid and a first quantity of sodium sulphate was added to the tailing sample in a pre-leaching step. The acid used in the pre-leach stage was deducted from the overall acid addition for the tests with the balance amount (the second quantity) being introduced during the leaching stage, as will be discussed later. In some cases, antifoaming agents were used to reduce foam formation as discussed in further detail below.

The acidified pre-leach slurry was maintained at a temperature of below 100° C. in order to prevent any evaporation of the water from the slurry. Maintaining the temperature below 80° C. was considered sufficiently suitable during these tests. Slurry density (before acid addition) was maintained in the range of 25-35% solids (w/w). Preferably, slurry density in the range of 30-35% solids (w/w) was found to be suitable. More preferably, slurry density in the range of 30.5-31.9% solids (w/w) was found to be suitable.

In the present embodiments, the inventors have surprisingly found that the roasting step can be avoided and replaced by a novel sequence of process or method steps as explained in the following sections. Currently known methods of lithium extraction from lithium containing ores require optimal roasting temperatures of 600° C. or greater which involves expending large quantities of energy to generate such heat. As a result, processes that involve roasting are generally more expensive and result in greater levels of carbon emissions. It had been previously believed that heating the lithium containing minerals to such high temperatures (600° C. or above) was essential to ensure that the three-dimensional structure undergoes significant change which thereby makes lithium extraction easier.

During the laboratory tests carried out to exemplify the preferred embodiment, tap water was used for preparing the initial aqueous suspension. The moist sample (826 g moist equivalent to 750 g dry) was slurried in potable water at close to 30% solids density/concentration. The small amount of water required to make a 30% solids slurry was retained separately for washing the pre-leach slurry into an autoclave vessel and for flushing the acid injection system as will be discussed. The pre-leach slurry was heated to 80° C. using a thermostatically controlled hotplate during test conditions. Importantly, the feed mixture was not subject to a roasting step.

Calcium lignosulphonate was added to the slurry to help reduce frothing. Concentrated sulphuric acid (98%) was slowly added to the reactor and froth was generated. The first quantity of concentrated sulphuric acid added during the pre-leaching step was 45-70% and preferably 60% of the total concentrated sulphuric acid used in the preferred embodiment of the method. 100 kg of Sodium Sulphate per tonne of feed mixture was also added to the slurry. During the tests, the total acid in solution and slurry pH were tested every fifteen minutes. It would be understood that the verification steps such as checking and recording slurry pH or slurry density during laboratory tests is not limiting in any manner and the method may be easily carried out for lithium extraction by not conducting such readings at regular time intervals.

At the end of the pre-leach period (1.5-2 hours) the acidified slurry was weighed and poured into an autoclave vessel and the pre-leach reactor washed with the small amount of water retained for this purpose. The washings were added to the slurry in the autoclave vessel. The table below shows the results for the pre-leach solution as analysed in the laboratory.

Clay tailings pre-leach Testwork Results

| | | | | | | Balance | |
|---|---|---|---|---|---|---|---|
| | | | | | | of 100% | Total of |
| | Pre- | Calcium | 100% | | | H₂SO₄ to | 100% |
| | Leach | Lignosulphonate | H₂SO₄ | Start | Final | Pressure | H₂SO₄ to |
| | Before | Added | Added | Slurry | Slurry | Leach | Test |
| Test No. | Test | (kg/tonne) | (kg/t) | pH | pH | (kg/tl) | (kg/tl) |
| 1 | MTAL | 10 | 253 | 8.64 | 1.99 | 197 | 450 |
| | Test #1 | | | | | | |
| 2 | MTAL | 5.3 | 249 | 9.03 | 1.55 | 201 | 450 |
| | Test #2 | | | | | | |
| 3 | MTAL | 5.3 | 251 | 9.02 | 2.15 | 199 | 450 |
| | Test #3 | | | | | | |

The autoclave vessel functions as a pressurised reactor and the acidified slurry was subjected to pressures in the range of 500 kPa to 4000 kPa. It was found that maintaining pressures in the range of 1000 kPa to 3500 kPa was suitable for the pressurised leaching step. Operating temperature in the autoclave was maintained below 250 degrees. As shown in the table, Examples 1, 2 and 3 were subject to temperatures of 175° C., 200° C. and 215° C. respectively during the pressurised leaching step.

Clay tailings - MTAL Testwork Conditions

| | H₂SO₄ | | | | Final | Final | Final |
|---|---|---|---|---|---|---|---|
| | Added | MTAL | | Defoamer | Liquor | Liquor | Liquor |
| | (kg/t as | Temperature | Pre- | Added | ORP | Fe²⁺ | Free Acid |
| Test No. | 100%) | (° C.) | Leach | (kg/t) | (mV) | (mg/l) | (g/l) |
| 1 | 400 | 175 | Yes | 10 | +487 | 100 | 20.95 |
| 2 | 400 | 200 | Yes | 10 | +490 | 50 | 19.36 |
| 3 | 400 | 215 | Yes | 10 | +482 | 500 | 36.37 |

Prior to commencing leaching in the autoclave, the second quantity of concentrated sulphuric acid was injected into the autoclave vessel to further promote the leaching stage that is being carried under pressure as previously described. In addition, antifoaming agents (namely calcium lignosulphate) were also injected into the autoclave vessel during the leaching stage. During tests it was found that leaching residence times of up to 60 minutes was suitable for achieving adequate leaching of Lithium ions into solution.

Overall acid addition (which is the sum of the first and second quantities of concentrated sulphuric acid) of around 400 kg of concentrated sulphuric acid per tonne of feed mixture was considered suitable. 100 kg of sodium sulphate per tonne of feed mixture was also added to form the initial slurry. During the laboratory tests, the autoclave was heated to an intermediate temperature that was at least 5 degrees below the target temperature (175, 200 and 215° C. respectively for Examples 1, 2 and 3) for each example and then the second quantity of acid was added to the autoclave.

The following table shows the results of quantitative tests carried out in the slurry post leaching to assess the overall leaching efficiency for Examples 1, 2 and 3.

Clay tailings - MTAL Testwork Results

| | Al | B | Fe | K | Li | Mg |
|---|---|---|---|---|---|---|
| | Extraction | Extraction | Extraction | Extraction | Extraction | Extraction |
| Test No. | (%) | (%) | (%) | (%) | (%) | (%) |
| 1 | 4.4 | 71.7 | 5.9 | 0.5 | 60.3 | 57.0 |
| 2 | 3.5 | 96.9 | 3.5 | 2.2 | 89.8 | 87.8 |
| 3 | 3.1 | 96.3 | 15.6 | 2.6 | 85.5 | 85.1 |

Lithium extraction rates that are as high as 89.8% indicate that a significant proportion of the Lithium ions that are usually trapped within the layers of the lithium containing clay material in the starting feed mixture was leached into solution. Such high extraction rates were not only achieved without the undesirable roasting step but also required lower quantities of sulphuric acid. In comparison, some of the other known methods can require 600 kg/tonne or higher levels of sulphuric acid. Costs associated with sulphuric acid can be a significant factor when it comes to determining viability of lithium extraction processes from clay materials and the surprisingly lower level of concentrated sulphuric acid required for the present embodiments presents significant cost advantages when compared to the prior art. It is also envisioned that addition of sodium sulphate may further reduce the requirement of sulphuric acid in the lithium extraction process.

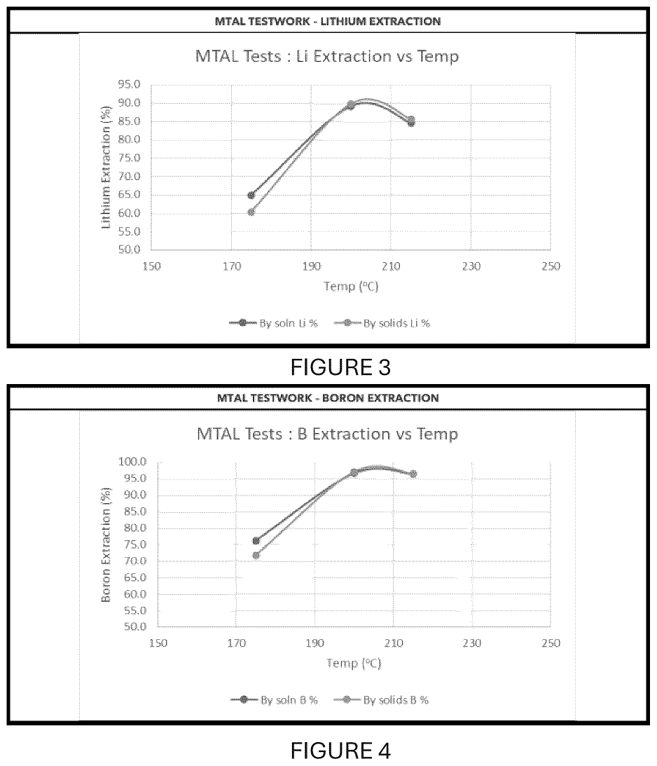

As shown in FIGS. 3 and 4, there appears to be a drop off in lithium recovery at the higher end of the test variable range, in this case temperature. Leach residue grades for lithium were 900, 300 and 400 ppm for 175, 200 and 215° C. leach temperature respectively.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A method for the extraction of lithium from a feed mixture comprising ore containing lithium, the method comprising the steps of:
preparing an initial aqueous suspension of the mixture without undertaking roasting of the feed mixture of ores;
adding sulphuric acid or a sulphuric acid precursor and an alkali sulphate to the suspension;
pressurizing the aqueous suspension in a reaction vessel to obtain a pressurized suspension such that pressure within the reaction vessel does not exceed 4000 kPa; while maintaining temperature of the pressurized suspension to prevent boiling of the aqueous suspension and obtain a leachate comprising dissolved lithium sulphate;
wherein an initial first quantity of sulphuric acid is added to the suspension wherein the temperature of the suspension is below 100° C. and wherein a subsequent second quantity of sulphuric acid is added to the suspension when the suspension is pressurized in the reaction vessel.

2. A method in accordance with claim 1 wherein the alkali sulphate comprises a monovalent alkali sulphate and preferably sodium sulphate.

3. A method in accordance with claim 1 wherein the step of adding sulphuric acid precursor comprises adding concentrated sulphuric acid.

4. A method in accordance with claim 1 wherein the pressure within the reaction vessel is in the range of 500 kPa to 4000 kPa and more preferably in the range of 1000 kPa to 3500 kPa.

5. A method in accordance with claim 1 further comprising the step of extracting lithium sulphate from the leachate.

6. A method in accordance with claim 1 wherein the ore containing lithium is selected from clay containing lithium, lithium bearing pegmatite and jadarite.

7. A method in accordance with claim 6 wherein the clay containing lithium is selected from smectite clay and illite clay.

8. A method in accordance with claim 1 wherein the lithium bearing pegmatite is selected from spodumene, lepidolite, petalite, amblygonite and zinnwaldite, preferably lepidolite and petalite.

9. A method in accordance with claim 1 wherein the feed mixture is derived from tailings or tailings mixtures.

10. A method in accordance with claim 9 wherein tailings or tailings mixtures are derived from processing lithium containing ores such including one or more of: spodumene, lepidolite, petalite, amblygonite, zinnwaldite and jadarite.

11. A method in accordance with claim 1 wherein the step of preparing an aqueous suspension of the mixture is carried out to achieve a predetermined solids concentration in the suspension.

12. A method in accordance with claim 10 wherein the predetermined solid concentration is less than 50% (w/w) and more preferably in the range of 25% to 40% (w/w).

13. A method in accordance with claim 1 wherein the step of preparing the initial aqueous suspension is carried out at a temperature to maintain the suspension in liquid phase under atmospheric conditions.

14. A method in accordance with claim 1 wherein temperature of the initial suspension is preferably below 100 degrees or below 90 degrees or below 85 degrees.

15. A method in accordance with claim 1 wherein the step of preparing the initial aqueous suspension with the added sulphuric acid or sulphuric acid precursor and alkali sulphate to form a pre-leaching suspension is followed by allowing the pre-leaching suspension to be maintained in a pre-leaching state for a period in the range of 30 minutes to 120 minutes.

16. A method in accordance with claim 1 wherein temperature of the pressurized suspension is maintained at or below 300° C. and preferably below 250 degrees Celsius.

17. A method in accordance with claim 1 wherein the step of pressurizing is carried out for a time period in the range of 30 minutes to 90 minutes.

18. A method in accordance with claim 1 wherein the step of pressurizing is carried out for a time period of at least 60 minutes.

19. A method in accordance with claim 1 further comprising the step of adding an anti-foaming agent, preferably calcium lignosulphate.

20. A method in accordance with claim 1 wherein less than 500 kg of concentrated sulphuric acid per tonne of feed mixture is added to the aqueous suspension.

21. A method in accordance with claim 1 wherein less than 450 kg of concentrated sulphuric acid per tonne of feed mixture is added to the aqueous suspension.

22. A method in accordance with claim 1 wherein at least 40 kg and preferably at least 50 kg of alkali sulphate per tonne of feed mixture is added to the suspension.

23. A method in accordance with claim 1 wherein at least 75 kg and more preferably at least 100 kg of alkali sulphate per tonne of feed mixture is added to the suspension.

24. A method in accordance with claim 1 wherein the first quantity of sulphuric acid is from at least 45% up to at least 70% of the total sulphuric acid being added to the suspension and wherein the second quantity of sulphuric acid is from at least 30% up to at least 55% of the total sulphuric acid being added.

25. A method in accordance with claim 1 wherein the first quantity of sulphuric acid is at least 50% and more preferably at least 60% of the total sulphuric acid being added to the suspension and wherein the second quantity of sulphuric acid is 50% or less than 50% of the total sulphuric acid being added and more preferably 40% or less than 40% of the total sulphuric acid being added.

26. A method in accordance with claim 1 wherein the pH of the suspension after the initial first quantity of sulphuric acid is added is from at least 0.5 up to at least 3.

27. A method in accordance with claim 1 wherein the solid concentration of the suspension after the initial first quantity of sulphuric acid is added is less than 50% (w/w) and more preferably in the range of 25% to 40% (w/w).

28. A method in accordance with claim 1 wherein the feed mixture comprises particles have a P80 size ranging from 10 μm to 20 μm and more preferably 12 μm to 15 μm.
